(19) United States
(12) Patent Application Publication
(10) Pub. No.: US 2018/0269702 A1
(43) Pub. Date: Sep. 20, 2018

(54) PORTABLE POWER CHARGER WITH CUSTOMIZABLE AESTHETIC FEATURE

(71) Applicant: Halo2Cloud, LLC, Hartford, CT (US)

(72) Inventors: Garold C. Miller, Hartford, CT (US); Nathan Daniel Weinstein, Hartford, CT (US)

(21) Appl. No.: 15/921,768

(22) Filed: Mar. 15, 2018

Related U.S. Application Data
(60) Provisional application No. 62/471,489, filed on Mar. 15, 2017.

(51) Int. Cl. H02J 7/00; H01M 10/46; F21L 4/08; H01M 10/44

(52) U.S. Cl. CPC H02J 7/0054; H01M 10/46; F21L 4/08; H02J 7/0045; H01M 10/441; H02J 7/0068; H02J 7/0044

(57) ABSTRACT

A portable power charger is provided for charging one or more electronic devices from an internal rechargeable battery and includes a customizable aesthetic feature that can be secured within an indented cavity provided on a face of the charger housing. The aesthetic feature can comprise a tile or chip adapted to fit into the indented cavity and that can be customized, for example, with different patterns, textures, colors, words, etchings, images, icons, logos and the like. A transparent cover can be snap fitted over the tile to secure it in place on the charger housing. The tile can be customized on both sides and flipped as desired within the indented cavity. A customized and personalized power charger kit can comprise a portable power charger and several interchangeable tiles that can be secured within the cavity and changed out and replaced as desired.

### CROSS-REFERENCE TO RELATED APPLICATION

This application claims the benefit of U.S. Provisional Application No. 62/471,489, filed Mar. 15, 2017, the entirety of which is incorporated herein by reference.

### TECHNICAL FIELD OF THE INVENTION

The invention relates to mobile electronic devices and, more particularly, to portable power chargers for such devices.

### BACKGROUND OF THE INVENTION

Battery-powered portable electronic devices, such as cellular phones, have become ubiquitous. Present day consumers typically own several electronic devices specifically designed for portability and use on-the-go, including, for example, a mobile phone or smart phone, a portable music player like an iPod or an MP3 player, a tablet, a portable gaming unit, a digital camera or camcorder, and the like. Also ubiquitous is a problem that the battery of a portable electronic device can run out of battery charge (i.e., become depleted) during use of the device, or while the device is being carried around. Once depleted, the battery needs to be recharged which requires the electronic device to be connected to a power source. Typically, these devices require frequent recharging, and utilize a charging cable for connecting the device to a power source, such as a wall outlet, a car charger, an airplane charger, or a computer. However, even when the device is connected to an external power source for recharging, it is difficult to continue using the device, as the device needs to remain tethered to the power source during charging.

Similarly, a separate charging cable is usually required for connecting an electronic device with a particular power source. For example, a consumer will have one cable for charging a phone at home with an AC wall socket, and another cable for charging the phone in the car using the DC car charging socket, and perhaps additional cables for charging the phone using a computer or on an airplane. Moreover, different electronic devices often utilize different connection ports and interfaces such that a single charging cable is not compatible with multiple devices. Accordingly, a tech-savvy consumer, with several electronic devices, will usually have multiple charging cables to keep track of, and find a place to store each applicable charging cable when on the move. Even then, the consumer may be without sufficient power to recharge a phone due to bad weather or a power outage, or may not always be in a place where a power source is readily available, or even if so, may not have the appropriate cable or adapter available to use with a particular power source. Furthermore, the consumer may not always be in a place where a power source is readily available, for example, if they are at the park, or may not have the appropriate cable or adapter available to use with a particular power source, for example, they are in the office but left their charging cable at home, or may be without sufficient power to recharge a phone or other device due to bad weather or a power outage.

On occasion, an electronic device needs a small amount of charge to finish a task before the device powers down due to insufficient battery capacity. For example, a user on a call using a mobile phone may wish to finish the call, but cannot find a power source to plug into, may not have enough time to get to a power source, or may not have the appropriate charging cable with her at the time. As noted, if the phone is plugged into a traditional power source, like a wall socket, it is difficult to continue using the phone as desired. Accordingly, what is needed is a power charger, even with a small boost of power, that is as portable as the electronic device and preferably easy to carry with the electronic device and the appropriate charging cable, and thus easily usable on-the-go.

Nonetheless, it is desirable to keep a charger handy and close by—where a user carries a charger, a depleted portable electronic device can continue to be used while charging. However, where the user does not carry a charger with the device, a depleted portable electronic device becomes unusable until the user can get to an external power source, assuming the user also has a charging cable handy for connection to the power source. Portable power chargers designed for use on-the-go must be suitable to a variety of conditions, as they are often most in need where a standard external power source is not available, and thus often needed when there is no power at all. For example, a portable power charger is especially useful when walking, camping, at the park, at the mall, or at a sporting event, where one may need to use a phone in an emergency situation.

In such situations, some users may want to have chargers that are aesthetically pleasing and don't just look like a portable power charger or another electronic device. It is common for users to decorate their electronic devices through a variety of means—including but not limited to decorative cases, stickers, and the like. It is therefore desirable to have a portable charger that can be readily and easily aesthetically modified for use as a fashion accessory.

Accordingly, in view of the foregoing, there is a need for a portable power charger usable with commonly available portable electronic devices that is easy to transport and is aesthetically pleasing and customizable so a fashion-conscious user will not be deterred from carrying it in public. Further, it is desirable to have a portable power charger with an aesthetic feature that is customizable, and even further, can be easily changed as desired. Accordingly, it is a general object of the present invention to provide a decorative portable power charger that improves upon conventional chargers on the market and overcomes the problems and drawbacks associated with such prior art portable chargers.

### SUMMARY OF THE INVENTION

Embodiments of the present invention provide a portable power charger comprising a charger housing having an internally disposed rechargeable battery unit operatively connected with at least one power connection interface that can act as a power input, a power output, or both. In accordance with preferred embodiments, at least one face of the charger housing includes an indented cavity adapted to receive an aesthetic feature, such as a tile or chip, adapted to fit into the indented cavity and that can be customized, as desired.

As noted, the aesthetic feature can be a tile that can be decorative and personalized, as desired. For example, the user can add a sticker to one or both sides of the tile. In this regard, the tile can be flipped to change the design that is seen when the tile is installed in the indented cavity. Alternatively, predesigned tiles may also be used in the indented cavity. That is, tiles can be provided with different patterns, textures, colors, words, etchings, images, icons, logos and the like. For example, a user can include or emboss her name into a tile with a customized design, thereby personalizing the charger.

The aesthetic feature can also comprise multiple tiles that are interchangeable so as to customize the color, texture, pattern, wording and/or images used on the charger housing, perhaps to coordinate with one's clothing or other accessories.

In an aspect of the present invention, the tile is secured in the indented cavity, and more preferably, releasably secured in the indented cavity for easily removal and replacement, as desired. For example, the tile can snap-fit into the cavity. In embodiments, projections or means can be provided in the indented cavity to hold the tile in place. In an alternate embodiment, a clip-on cover is provided to hold the tile in the cavity. Preferably, the tile can also be flipped and reoriented within the cavity to take advantage of both sides of the tile for customized decoration.

In an alternate embodiment, a backside of the tile can include an adhesive to attach the tile into the indented cavity. Further, the backside of the tile can include one or more suction cups. Still further, the face of the indented cavity and the backside of the tile can include complementary magnets or hook-and-loop fasteners for positioning and securing the tile in place on the charger housing.

The power connection interface used with the charger of the present invention can comprise a power connection port or a power connection cable interface attached to the charger housing and in operative communication with the internal rechargeable battery unit. In preferred embodiments, multiple combinations of power connection ports and/or charging cables with power connection interfaces are included for connecting the portable charger with electronic devices in need of a charge and an external power source when the internal rechargeable battery unit needs a charge of its own. Where charging cables are provided, it is preferable that the charger housing includes storage cavities for housing such cables when not in use so as not to deter from the size and aesthetics of the charger, especially when not in use. When a charging cable is needed to connect to an electronic device or an external power source, the cable can be flexed out of its cavity for such connection.

In an alternate embodiment of the present invention, the charger housing can include a dedicated power input connection interface, such as an AC connection plug or a DC car charger interface.

Alternatively, charging pins can be provided on the charger housing for direct connection to a complementary power source, such as a charging cradle, for recharging the internal battery unit.

The power charger can also include components for wireless charging, such as a wireless transmitter to wirelessly connect to and charge an electronic device having a wireless receiver, and a wireless receiver for wirelessly receiving a charge from a wireless transmission base for recharging the internal battery unit. An indicator can be provided to indicate when the internal battery is charging, or when the capacity of the battery unit is full or empty.

A portable charger in accordance with the present invention can also include additional features such as a power indicator means, a manual power on/off button, a flashlight feature, and a flashlight power on/off button.

In general, the portable power charger can be used with a variety of devices, including but not limited to phones, tablet computing devices, portable computers, cameras, video cameras, Bluetooth devices, navigation systems, portable music players, speakers, and other portable electronics.

These and other objects, features and advantages of the present invention will become apparent in light of the accompanying drawings as described below.

### BRIEF DESCRIPTION OF THE DRAWINGS

FIG. 1 illustrates a front planar view of a portable power charger in accordance with the present invention with a decorative tile removed from an indented cavity formed in the charger housing.

FIG. 2 illustrates the backside of the decorative tile of FIG. 1.

FIG. 3 illustrates a perspective view of an embodiment of a transparent clip-on cover adapted for use with the portable power charger of FIG. 1 to secure the tile in place within the indented cavity in accordance with an aspect of the present invention.

FIG. 4 illustrates a perspective front view of the portable power charger of FIG. 1 with the decorative tile in position.

FIG. 5 illustrates a perspective front view of the portable power charger of FIG. 1 with the decorative tile and the transparent cover in position.

FIG. 6 illustrates a rear planar view of the portable power charger of FIG. 1 with charging cables extended from the charger housing for use.

FIG. 7 illustrates an exploded perspective bottom view of the portable power charger of FIG. 1.

FIG. 8 illustrates a schematic for an embodiment of the portable power charger of FIG. 1 within which the customizable aesthetic feature of the present invention can be used.

### DETAILED DESCRIPTION OF THE DRAWINGS

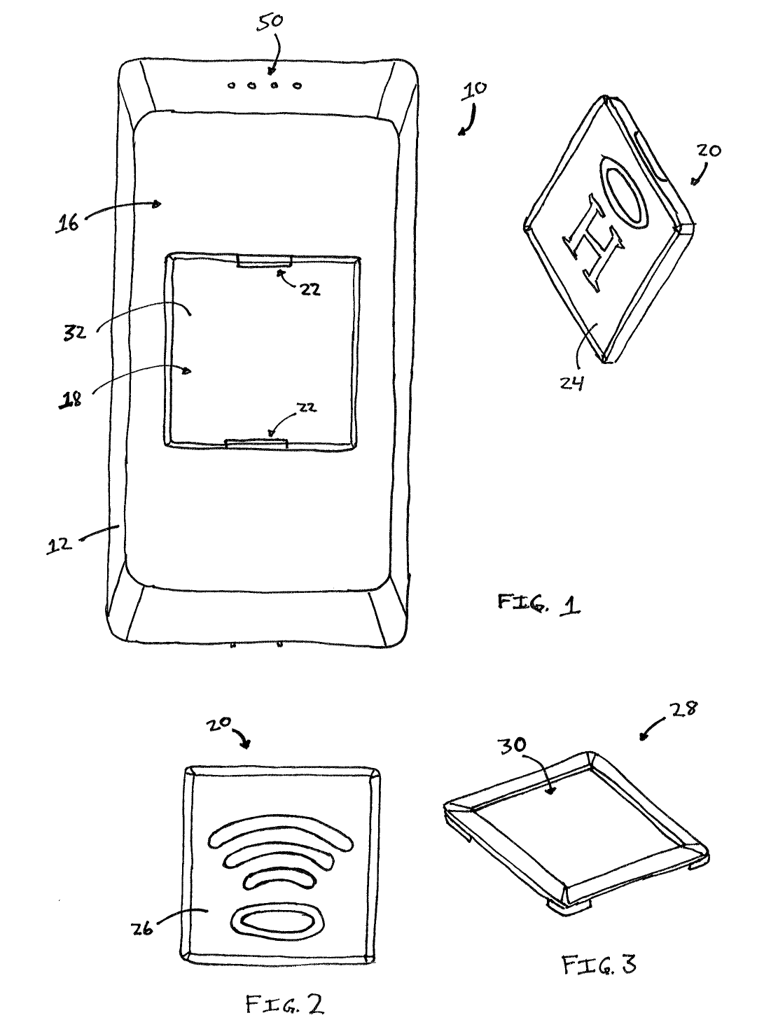

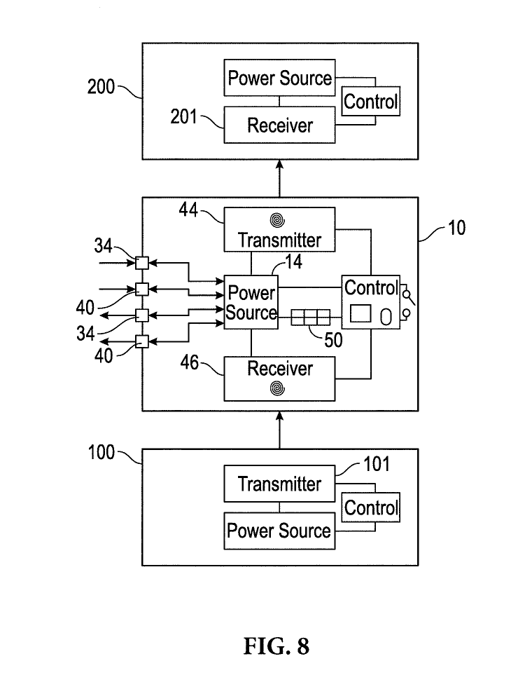

A portable power charger in accordance with embodiments of the present invention is shown in FIGS. 1-7. As illustrated, a power charger, generally designated as reference numeral 10, comprises a charger housing 12 having a rechargeable battery unit 14 (as schematically illustrated in the embodiment of FIG. 8) internally disposed therein and in operative communication with at least one power connection interface provided on the charger housing 12.

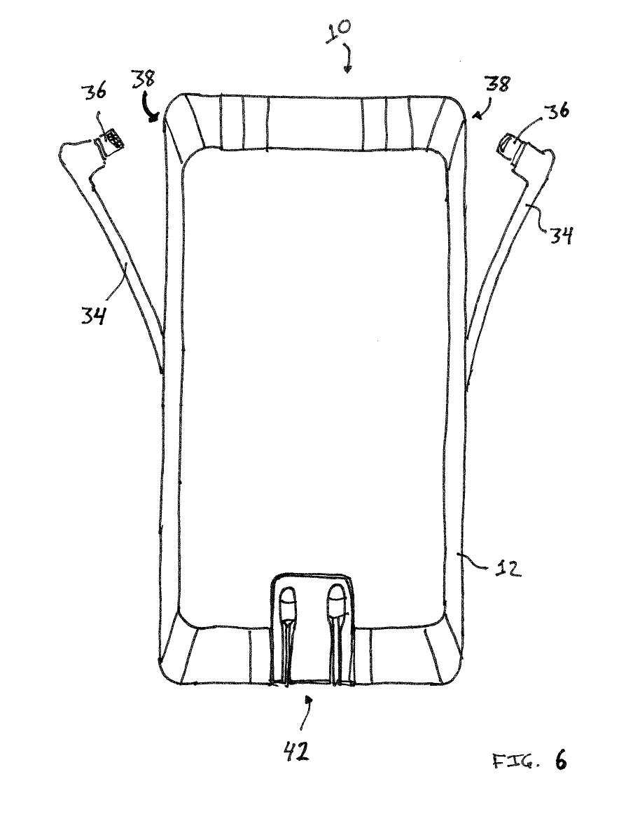

Referring to FIG. 1, the front face 16 of the charger housing 12 includes an indented cavity 18 formed therein and adapted to receive an aesthetic feature to customize and personalize the aesthetic appearance of the charger 10. The aesthetic feature, generally designated by reference numeral 20, can generally comprise a tile or chip insertable into and secured within the indented cavity 18 of the charger housing 12. As illustrated in FIG. 1, the tile 20 is removed from the indented cavity 18. As shown in FIG. 4, the tile 20 is positioned in place within the indented cavity 18.

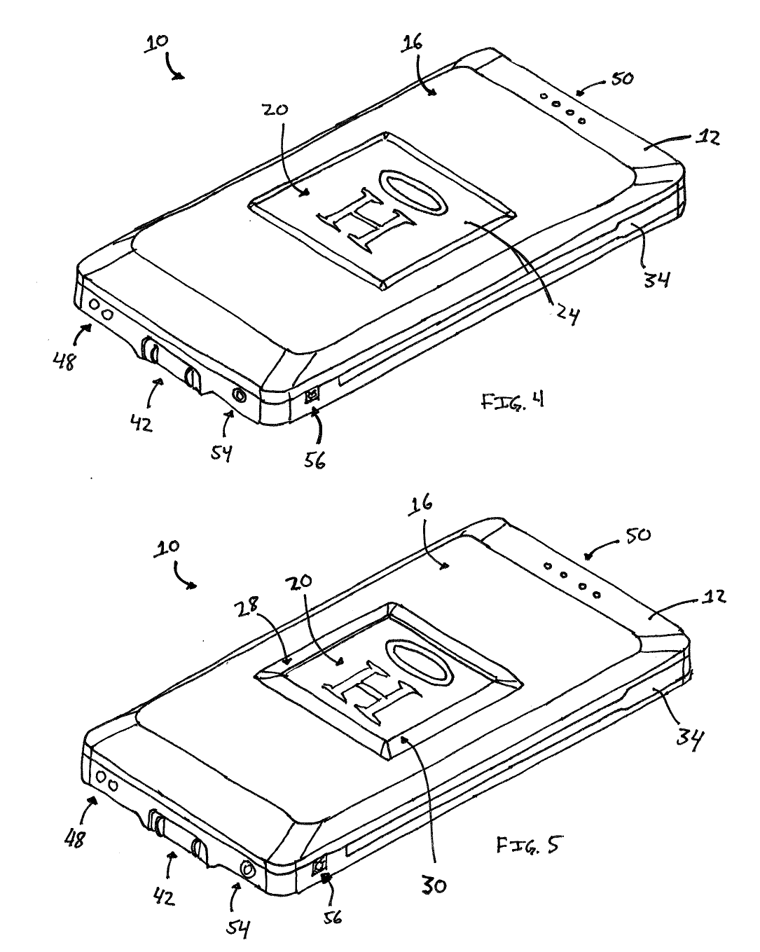

In accordance with the present invention, the tile 20 is a means for the user to customize and personalize the charger 10—for example, by adding aesthetic features to the tile's face to impart such aesthetics to the charger 10. In this regard, the user can add a sticker to one or both sides of the tile 20; write on or paint the tile 20; or etch or emboss the faces of the tile 20 with words, letters, designs, logos, other images or the like. For example, a user can include her name with a customized design, thereby personalizing the charger 10. Similarly, a company's logo can be used, as illustrated in FIG. 4. In preferred embodiments of the present invention, the tile 20 can be flipped to change the design that is seen when the tile 20 is installed in the indented cavity 18. For example, a company can supply a tile 20 with its logo and/or name as a promotional give-away and still allow a user to use the other side to add a personalized touch to the tile 20. In this regard, FIG. 1 illustrates a first side of the tile 20 with a first design, while FIG. 2 illustrates the backside of the tile 20 with a second design.

Predesigned tiles 20 may also be used in the indented cavity 18. That is, tiles 20 can be provided with different patterns, textures, colors, words, etchings, images, icons, logos and the like. The aesthetic feature can also comprise multiple tiles 20 that are interchangeable so as to customize the color, texture, pattern, wording and/or images used on the charger housing 12. A user can change tiles 20 in and out as desired, for example, to coordinate with the user's clothing for the day, or with other accessories like a phone, a purse or bag.

In an aspect of the present invention, the tile 20 is secured in the indented cavity 18, as illustrated in FIG. 4. For example, the tile 20 can snap-fit into the cavity 18. Projections or mechanical means 22 can be provided within or on the edge of the indented cavity 18 to hold the tile 20 in place once it is positioned in the cavity 18. In preferred embodiments, when the tile 20 is placed within the indented cavity 18, the outer surface 24 of the tile 20 is generally flush with the front face 16 of the charger housing 12. However, the tile 20 can be either recessed from the front face 16 of the housing 12 or project out from the housing 12, or even provide an aesthetic texture, without departing from the spirit and principles of the present invention.

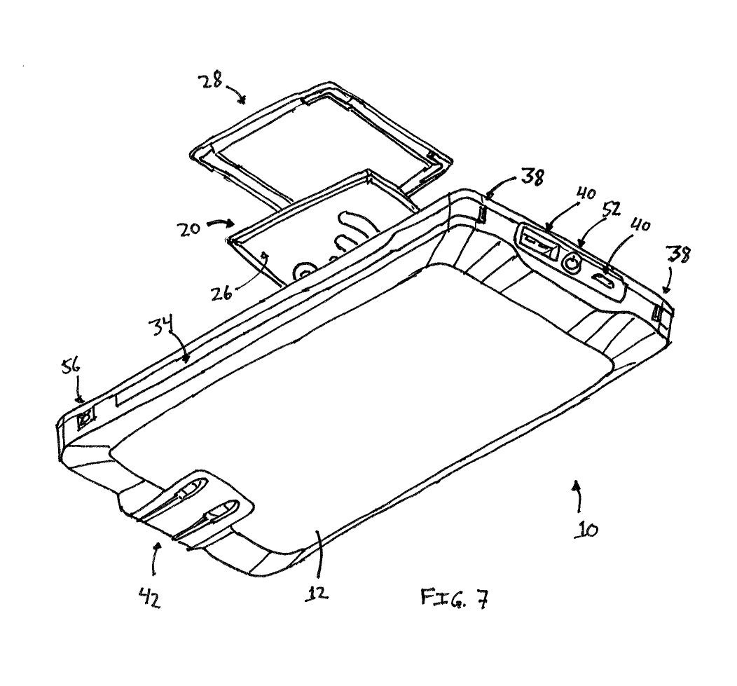

In an alternate embodiment, a clip-on cover 28, shown in FIG. 3, is provided to hold the tile 20 in the cavity 18. In use for such an embodiment, the tile 20 is placed within the indented cavity 18 and the cover 28 is snap-fitted around the tile 20 to secure it within the cavity 18, as illustrated in FIG. 5. In preferred embodiments, the cover 28 is transparent. In preferred embodiments when such a cover 28 is used, when the tile 20 is placed within the indented cavity 18 and the cover 28 is fitted into place, the outer surface 30 of the cover 28 is generally flush with the front face 16 of the charger housing 12. However, the cover 28 can be either recessed from the front face 16 of the housing 12 or project out from the housing 12, or even provide an aesthetic texture, without departing from the spirit and principles of the present invention.

In preferred embodiments of the present invention, each tile 20 is adapted to fit snugly within the indented cavity 18. However, the tile 20 is also preferably designed to be removable from the cavity 18. More preferably, the tile 20 can be flipped and reoriented within the indented cavity 18 to take advantage of both sides of the tile 20 for customized decoration. In an alternate embodiment, the tile can include attachment means for securing the tile 20 in place within the indented cavity 18. For example, a backside 26 of the tile 20 can include an adhesive layer to attach and secure the tile 20 into the indented cavity 18. Alternatively, the backside 26 of the tile 20 can include one or more suction cups for attachment within the indented cavity 18. Another embodiment can utilize a magnetic attachment system, whereby complementary magnets, or combinations of magnets and metallic pieces are respectively provided on the inner surface of the charger cavity 18 and the backside 26 of the tile 20. Still further, the interior surface 32 of the indented cavity 18 and the backside 26 of the tile 20 can include complementary hook-and-loop fasteners for positioning and securing the tile 20 in place within the charger housing 12.

As noted, the tile 20 permits a user to customize and personalize the aesthetic appearance of the portable charger 10. The material, color, texture, pattern or imagery provided on the face of the charger 10 can be changed. Additionally, tiles 20 can comprise jewels, like embedded rhinestones, or printed and/or embossed features, like a logo, name, image, wording, lettering, or the like. Still further, an LED light can be positioned beneath the indented cavity 18 to illuminate the tile 20 (e.g., a transparent or translucent tile, or an opaque tile with a transparent or translucent design, word or image formed thereon) when positioned therein so that whatever design is provided on the tile 20 will light up or glow. For example, in the embodiment illustrated in FIG. 4, the “H” and halo design may be illuminated by such an LED. Such illumination can have more than merely an aesthetic purpose. That is, the illumination of the tile 20 or logo thereon may provide an indication that the charger 10 is on and working or connected with an electronic device for charging, either directly or wirelessly, as discussed below. Alternatively, the illumination could provide an indication of the battery capacity of the charger 10, perhaps by altering colors or switching between solid illumination and blinking.

Though illustrated herein as a square to be fitted to one face of the charger housing 12, the shape and size of the tile 20, and location, size and number of the indented cavity 18 can be modified without departing from the spirit and principles of the present invention. Further, the tile 20 can be rigid or flexible. Additionally, aesthetic tiles 20 in accordance with the present invention can be provided on multiple faces of the charger 10. Additionally, the design of the charger housing 12 provided in the present description and drawings can be varied, as the customizable aesthetic feature 20 of the present invention described herein can be used with various charger housing designs, shapes and sizes. Still further, the present invention envisions use of multiple tiles 20 on a face of a charger housing 12, permitting a user to create a decorative mosaic on the charger 10, as desired.

Referring to FIGS. 6-7, a particular portable power charger design with which the present invention can be used is illustrated. As noted, the aesthetic feature 20 of the present invention can be used with any charger housing design without departing from the spirit and principles of the present invention. In preferred embodiments, the charger housing 12 is provided with at least one power connection interface that can act as a power input, a power output, or both. More particularly, the power connection interface used with the charger 10 of the present invention can comprise a power connection port, or a power connection cable interface attached to the charger housing 12 and in operative communication with the internal rechargeable battery unit 14. Additionally, wireless charging components, such as a wireless transmitter, a wireless receiver, and/or NFC antennas, can be provided within the charger housing 12 for transmitting or receiving a charge. In preferred embodiments, multiple combinations of power connection ports and/or charging cables with power connection interfaces and/or wireless charging components are provided for connecting the portable charger 10 with electronic devices in need of a charge and an external power source when the internal rechargeable battery unit 14 needs a charge of its own.

As shown in FIG. 6, the illustrated charger housing 12 includes two charging cables 34 with male power connection interfaces 36 for connection to electronic devices in need of a charge from the internal rechargeable battery unit 14 of the power charger 10. In alternate embodiments, one of the charging cables 34 can be a power input for recharging the internal rechargeable battery unit 14 when the charger 10 is connected to an external power source via the charging cable 34. Still further, one or both charging cables 34 can be designed to act as both a power input and a power output depending on what is connected to the end of the cable 34.

The illustrated charging cables 34 are adapted for storage within storage cavities 38 formed within the charger housing 12. That is, when a charging cable 34 is not needed, it can be stored within a cavity 38 so as not to deter or detract from size or the aesthetic appearance of the charger 10. When a cable 34 is needed, it can be flexed out of its cavity 38, as shown in FIG. 6, for connection to an electronic device or an external power source.

Referring to FIG. 7, the charger housing 12 can alternatively or additionally include one or more power connection ports 40 operatively communicating with the internal rechargeable battery unit 14. Such ports 40 can operate as either a power input, a power output, or both, depending on what is connected to the port via a charging cable connected thereto. In this regard, a connection port 40 can be a power input to recharge the internal rechargeable battery unit 14 if the charger 10 is connected to an external power source via the port 40. Similarly, the port 40 could be a power output for supplying a charge from the internal rechargeable battery unit 14 to an electronic device connected to the charger 10 via the port 40.

Referring again to FIGS. 6-7, the charger 10 may further include a dedicated power input connection, such as the illustrated AC wall plug 42 that, as illustrated, can be retracted to a non-use storage position within the volume of the charger housing 12 when not needed, and pivoted out to a use position, when needed. The plug 42 is in operative communication with the internal rechargeable battery unit 14 so as to provide a charge to the battery 14 for recharging when the plug 42 is connected to a wall socket. In alternate embodiments, a DC car charger interface can be provided for recharging the internal rechargeable battery unit 14. As previously noted, one of the charging cables 34, or one of the power connection ports 40 on the charger 10 can act as a power input for recharging the internal rechargeable battery unit 14 as well when connected to an external power source.

In another embodiment of the present invention, wireless charging means can be provided within the charger housing 12 and in operative communication with the internal rechargeable battery unit 14. For example, referring to FIG. 8, a wireless transmitter 44 and/or a wireless receiver 46 can be disposed within the charger housing 12 and be operatively connected with the internal rechargeable battery unit 14 for wireless operation of the charger 10. The wireless transmitter 44 would be used for wireless connection with an electronic device 200 having a complementary wireless receiver 201 for providing a charge from the internal rechargeable battery unit 14 of the charger 10 to the electronic device 200. Similarly, the internal rechargeable battery unit 14 can be recharged itself, by wireless interface with a wireless transmission device 100, such as a wireless charging pad via the wireless receiver 46, which interacts with a complementary wireless transmitter 101 in the wireless transmission device 100. In general, such a charger 10 would operate in the manner as shown and described in Applicant's U.S. Pat. Nos. 9,318,915, 9,667,092 and 9,812,892, and co-pending U.S. application Ser. No. 15/725,385, each of which is incorporated herein by reference in its entirety.

Referring to FIG. 4, in alternate embodiments, power charging pins 48 can be provided on the charger housing 12 and in operative communication with the internal rechargeable battery unit 14 for direct recharging of the internal rechargeable battery unit 14 when the charger 10 is placed in or otherwise connected to a charging cradle with complementary electrical connections.

As illustrated in FIG. 1, a power indicator means 50 can be provided on the charger housing 12 to provide information about the battery capacity in the charger 10. Operation of the charger 10 can be controlled by a manual on/off button 52, as illustrated in FIG. 5. Alternatively, the charger 10 can automatically turn on to supply a charge once an electronic device is connected to the charger 10 via a charging cable 34, a power connection port 40, or the wireless transmitter 44, such as described in Applicant's co-pending U.S. application Ser. No. 15/826,832, which is incorporated herein by reference in its entirety.

Referring to FIG. 4, a flashlight 54, preferable using an LED, can be provided and controlled by a manual on/off button 56, illustrated on the side of the charger housing 12 proximate the flashlight 54.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A portable power charger with a customizable aesthetic feature comprising:
a charger housing having a rechargeable battery internally disposed therein and an indented cavity defined in a surface of the housing;
at least one power connection interface provided on the housing and in operative communication with the rechargeable battery; and
a decorative tile adapted to be fitted and secured in the indented cavity.

2. The portable power charger according to claim 1, wherein the decorative tile has an outer surface such that when the decorative tile is fitted and secured in the indented cavity, said outer surface is generally flush with the surface of the charger housing.

3. The portable power charger according to claim 1, wherein the decorative tile is secured in the indented cavity by snap-fitting it into place.

4. The portable power charger according to claim 3, wherein the indented cavity includes at east one projection for securing the decorative tile in place within the indented cavity.

5. The portable power charger according to claim 1, further comprising a transparent cover secured around the decorative tile once said tile is fitted within the indented cavity, whereby the cover secures the tile in place.

6. The portable power charger according to claim 5, wherein the transparent cover has an outer surface such that when the cover is secured around the decorative tile within the indented cavity, said outer surface is generally flush with the surface of the charger housing.

7. The portable power charger according to claim 1, wherein the decorative tile can be removed from the indented cavity and replaced therein by a second decorative tile.

8. The portable power charger according to claim 1, wherein the decorative tile includes a first face having an aesthetic feature thereon.

9. The portable power charger according to claim 8, wherein the aesthetic feature on the decorative tile comprises and embossed feature in the first face.

10. The portable power charger according to claim 1, wherein the decorative tile includes a first face and a second opposing face, each said face having a respective aesthetic feature thereon such that the decorative tile can be inserted in the indented cavity with either face exposed.

11. The portable power charger according to claim 1, wherein the at least one power connection interface is capable of operating as at least one of a power input and a power output,
wherein when said at least one power connection interface acts as a power input, an electrical charge current is provided from an external power source to the portable power charger for recharging the rechargeable battery when the portable power charger is connected to said external power source via said at least one power connection interface, and
wherein when said at least one power connection interface acts as a power output, a charge is provided from the rechargeable battery of the portable power charger to an electronic device to recharge the rechargeable battery of said electronic device when said electronic device is connected to the portable power charger via said at least one power connection interface.

12. The portable power charger according to claim 11, wherein the at least one power connection interface comprises one of a power connection port, a power connector cable, a wireless transmitter, a wireless receiver, an AC wall plug, and electrical contacts provided on the exterior surface of the charger housing, each operatively connected to the rechargeable battery.

13. A kit for customizing a portable power charger with an aesthetic feature, said kit comprising:
a charger housing having a rechargeable battery internally disposed therein and an indented cavity defined in a surface of the housing;
at least one power connection interface provided on the housing and in operative communication with the rechargeable battery; and
a plurality of interchangeable decorative tiles each adapted to be fitted and secured in the indented cavity of the charger housing.

14. The portable power charger according to claim 13, wherein the decorative tile has an outer surface such that when the decorative tile is fitted and secured in the indented cavity, said outer surface is generally flush with the surface of the charger housing.

15. The portable power charger according to claim 13, wherein the decorative tile is secured in the indented cavity by snap-fitting it into place.

16. The portable power charger according to claim 15, wherein the indented cavity includes at east one projection for securing the decorative tile in place within the indented cavity.

17. The portable power charger according to claim 13, further comprising a transparent cover secured around the decorative tile once said tile is fitted within the indented cavity, whereby the cover secures the tile in place.

18. The portable power charger according to claim 17, wherein the transparent cover has an outer surface such that when the cover is secured around the decorative tile within the indented cavity, said outer surface is generally flush with the surface of the charger housing.

19. The portable power charger according to claim 13, wherein the decorative tile includes a first face having an aesthetic feature thereon.

20. The portable power charger according to claim 19, wherein the aesthetic feature on the decorative tile comprises and embossed feature in the first face.

21. The portable power charger according to claim 13, wherein the decorative tile includes a first face and a second opposing face, each said face having a respective aesthetic feature thereon such that the decorative tile can be inserted in the indented cavity with either face exposed.

22. The portable power charger according to claim 13, wherein the at least one power connection interface is capable of operating as at least one of a power input and a power output,
wherein when said at least one power connection interface acts as a power input, an electrical charge current is provided from an external power source to the portable power charger for recharging the rechargeable battery when the portable power charger is connected to said external power source via said at least one power connection interface, and
wherein when said at least one power connection interface acts as a power output, a charge is provided from the rechargeable battery of the portable power charger to an electronic device to recharge the rechargeable battery of said electronic device when said electronic device is connected to the portable power charger via said at least one power connection interface.

23. The portable power charger according to claim 22, wherein the at least one power connection interface comprises one of a power connection port, a power connector cable, a wireless transmitter, a wireless receiver, an AC wall plug, and electrical contacts provided on the exterior surface of the charger housing, each operatively connected to the rechargeable battery.
